(19) United States
(12) Patent Application Publication
(10) Pub. No.: US 2012/0287063 A1
(43) Pub. Date: Nov. 15, 2012

(54) SYSTEM AND METHOD FOR SELECTING OBJECTS OF ELECTRONIC DEVICE

(75) Inventors: YU-CHUN CHEN, Tu-Cheng (TW); WEN-CHIEH KUO, Tu-Cheng (TW)

(73) Assignee: CHI MEI COMMUNICATION SYSTEMS, INC., Tu-Cheng (TW)

(21) Appl. No.: 13/427,885

(22) Filed: Mar. 23, 2012

(30) Foreign Application Priority Data
May 11, 2011 (TW) 100116417

(51) Int. Cl. G06F 3/041

(52) U.S. Cl. 345/173

(57) ABSTRACT

In a method for selecting objects of an electronic device, touch operations performed on a touch screen of the electronic device are detected in real-time. A selection region on the touch screen is determined according to a touch operation that is detected from the touch screen. Objects displayed on the touch screen are selected according to the determined selection region.

### BACKGROUND

1. Technical Field

Embodiments of the present disclosure relate to systems and methods for managing objects of electronic devices, and more particularly, to a system and method for selecting objects of an electronic device.

2. Description of Related Art

Electronic devices, such as smart mobile phones, personal digital assistants, and tablet computers, are widely used. The electronic devices may display objects, such as folders, pictures, and icons of applications using touch screens. In general, users select the objects by performing touch operations with fingers or styluses on the touch screens. However, the users have to select the objects one by one, or select all of the objects via a “select all” option. It is inconvenient for users if the users just want to select a part of the objects.

### BRIEF DESCRIPTION OF THE DRAWINGS

FIG. 1 is a block diagram of one embodiment of an electronic device including an object selecting system.

FIG. 2 is a schematic diagram of objects displayed on a touch screen of the electronic device of FIG. 1.

FIGS. 3A-5B are schematic diagrams of embodiments of methods for determining selection regions on the touch screen of the electronic device of FIG. 1.

FIG. 6 is a flowchart of one embodiment of a method for selecting objects of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

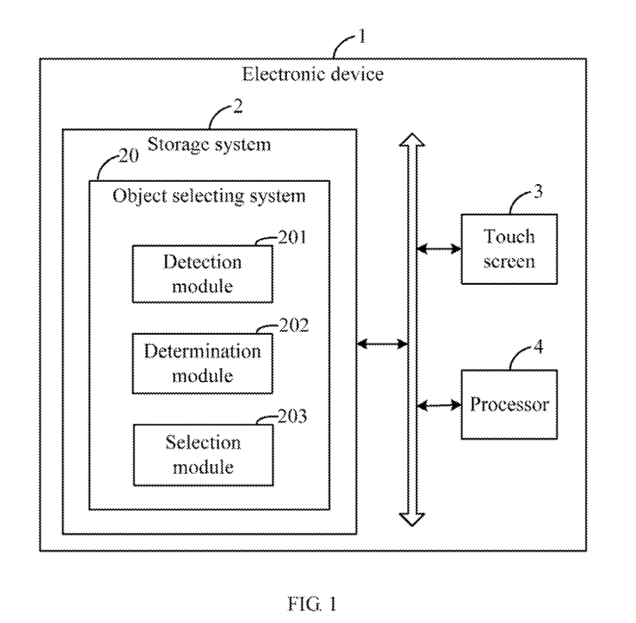

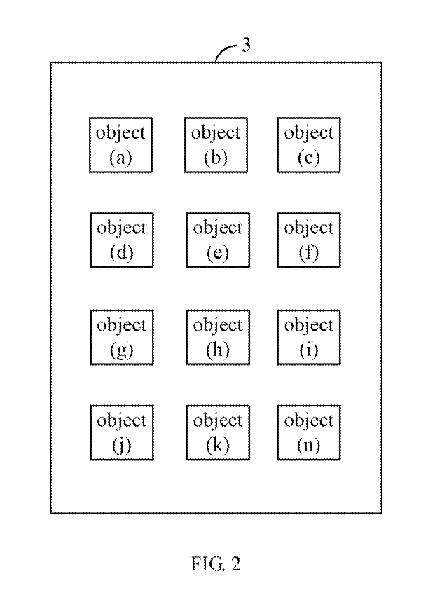

FIG. 1 is a block diagram of one embodiment of an electronic device 1 including an object selecting system 20. In the embodiment, the electronic device 1 further includes a storage system 2, a touch screen 3 that may be capacitive or resistive, and at least one processor 4. The touch screen 3 can display several objects of the electronic device 1, such as folders, pictures, and icons of applications. In one example, as shown in FIG. 2, the touch screen 3 displays twelve objects: object (a), object (b), . . . , and object (n). The electronic device 1 may be, for example, a mobile phone, a personal digital assistant, a handheld game console or a tablet computer. FIG. 1 is just one example of the electronic device 1 that can be included with more or fewer components than shown in other embodiments, or have a different configuration of the various components.

The object selecting system 20 may be in form of one or more programs that are stored in the storage system 2 and executed by the at least one processor 4. The object selecting system 20 can detect touch operations performed on the touch screen 3, and select the objects displayed on the touch screen 3 according to the detected touch operations. In the embodiment, the touch operations refer to the presence of one or more points of contacts (e.g., fingers or styluses), and any movement or break of the contacts that are simultaneously sensed by the touch screen 3.

In one embodiment, the storage system 2 may be a random access memory (RAM) for temporary storage of information, and/or a read only memory (ROM) for permanent storage of information. In other embodiments, the storage system 2 may also be an external storage device, such as a hard disk, a storage card, or a data storage medium. The at least one processor 4 executes computerized operations of the electronic device 1 and other applications, to provide functions of the electronic device 1.

In the embodiment, the object selecting system 20 may include a detection module 201, a determination module 202 and a selection module 203. The modules 201-203 may comprise a plurality of functional modules each comprising one or more programs or computerized codes that can be accessed and executed by the at least one processor 4. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The detection module 201 detects touch operations performed on the touch screen 3 in real-time. In the embodiment, the touch operations refer to the presence of one or more points of contacts and any movement or break of the contacts that are simultaneously sensed by the touch screen 3.

The determination module 202 determines a selection region on the touch screen 3 according to a touch operation that is detected from the touch screen 3. The touch operation may include two contacts on two points of the touch screen 3 or a movement track of one or two contracts on the touch screen 3. The selection region is defined as a polygon region, such as a rectangle region, a triangle region, or other irregular polygon region, that is determined according to the two contacts on two points of the touch screen 3 or the movement track of one or two contracts. Three methods for determining the selection region on the touch screen 3 are described below in paragraph [0014] to paragraph [0016].

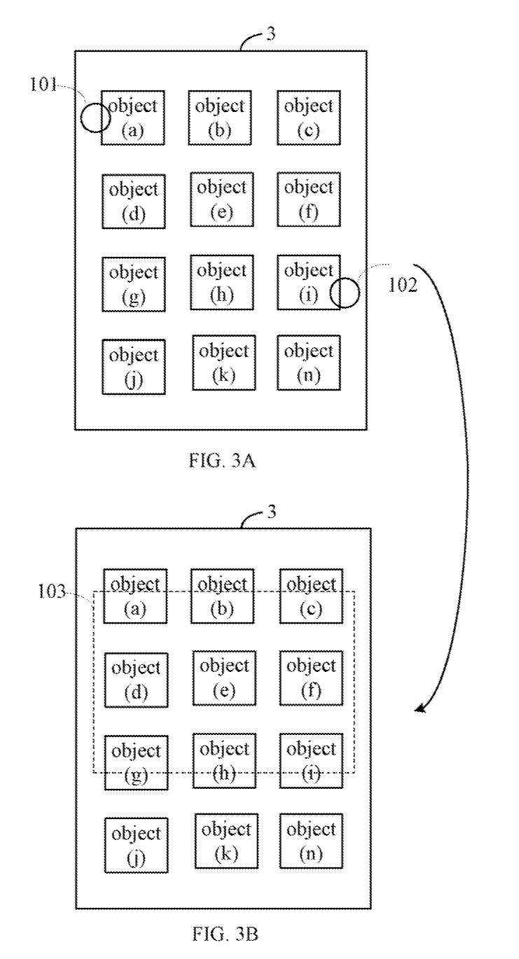

In one embodiment, if the touch operation with the two contacts on two points of the touch screen 3 is maintained for a predetermined time, such as one second or two seconds, for example, as shown in FIG. 3A, the two points on the touch screen 3 are point 101 and point 102, the determination module 202 determines a rectangle selection region on the touch screen 3. A diagonal of the rectangle selection region connects to the two points that are two vertices of the rectangle selection region. In addition, four sides of the rectangle selection region correspondingly parallel with four boundaries of the touch screen 3. Referring to FIG. 3B, the determination module 202 determines a rectangle selection region 103 according to the touch operation with the contacts on the point 101 and the point 102 of the touch screen 3 in FIG. 3A.

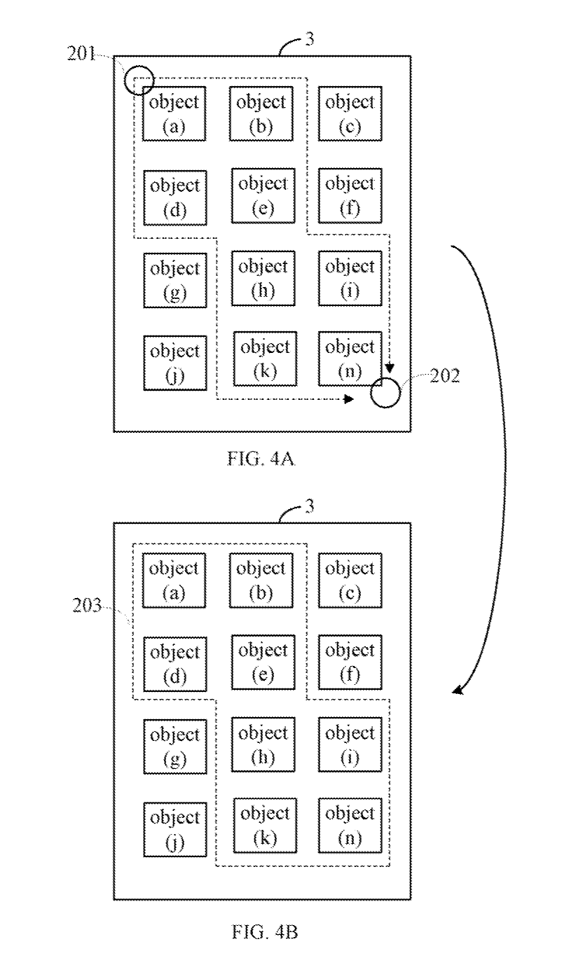

In another embodiment, the touch operation may include the two contacts that respectively and synchronously move from a start point of the touch screen 3 in a random direction, and stop moving on an end point of the touch screen 3. If the two contacts move from two points of the touch screen 3 at the same time, and one of the two points is close to another one, for example, a distance between the two points ranges from zero to five millimeters, the two points are considered as the coincident start point. In one example, as shown in FIG. 4A, the start point on the touch screen 3 is point 201, and the end point on the touch screen 3 is point 202. In response to the touch operation, the determination module 202 determines the selection region on the touch screen 3 according to the movement track of the touch operation with the two contacts. As shown in FIG. 4B, the determination module 202 determines a selection region 203 according to the touch operation with the contacts moving from the start point 201 to the end point 202 on the touch screen 3.

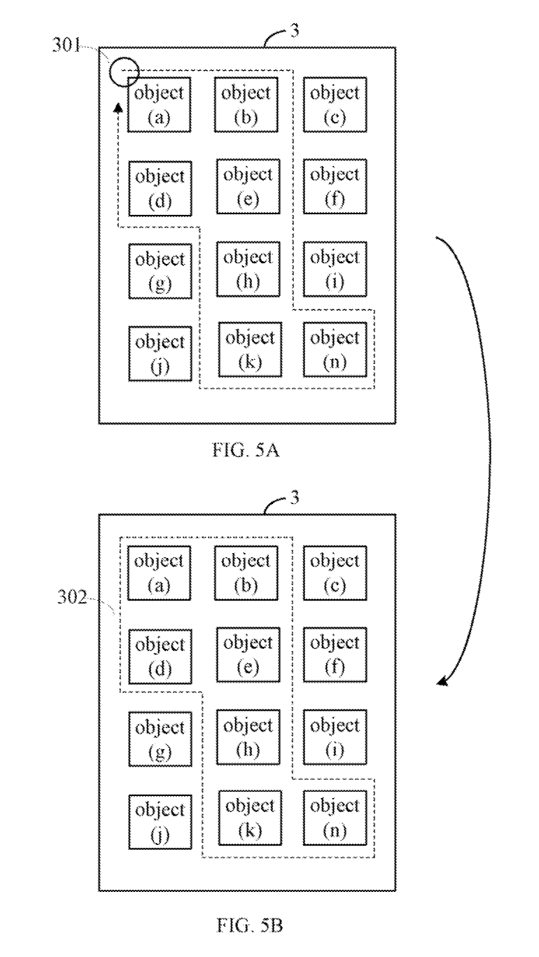

The touch operation may further include the one contact that moves from an origin point of the touch screen 3 in a random direction, and stops moving on the origin point. For example, as shown in FIG. 5A, the origin point on the touch screen 3 is point 301. The determination module 202 determines the selection region according to the movement track of the touch operation with the contact. As shown in FIG. 5B, the determination module 202 determines a selection region 302 according to the touch operation with the contact moving from the origin point 301 and end the movement on the origin point 301.

If the determination module 202 does not determine a selection region according to the touch operation, for example, the touch operation is clicking a point of the touch screen 3, it is fail to select the objects displayed on the touch screen 3.

The selection module 203 selects the objects displayed on the touch screen 3 according to the determined selection region. In one embodiment, the selection module 203 selects the objects located in the selection region. As shown in FIG. 4B, the selection module 203 selects the object (a), object (b), object (d), object (e), object (h), object (i), object (k), and object (n) that are located in the selection region 203. In another embodiment, the selection module 203 selects the objects whose locations are overlapping with the selection region. As shown in FIG. 3B, the selection module 203 selects the object (a), object (b), object (c), object (d), object (e), object (f), object (g), object (h), and object (i) whose location are overlapping with the rectangle selection region 103.

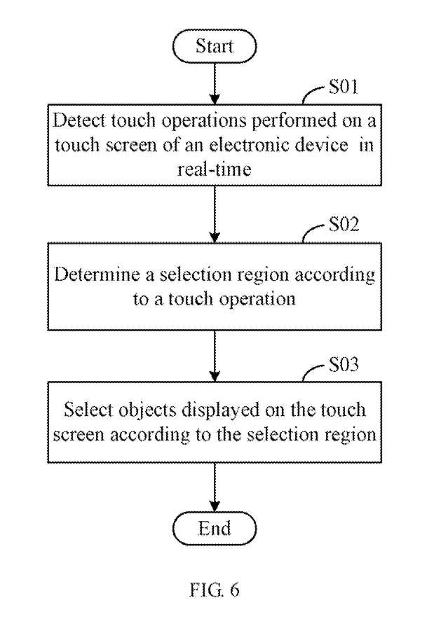

FIG. 6 is a flowchart of one embodiment of a method for selecting objects of the electronic device 1 of FIG. 1. Depending on the embodiment, additional blocks may be added, others removed, and the ordering of the blocks may be changed.

In block S01, the detection module 201 detects touch operations performed on the touch screen 3 in real-time. In the embodiment, the touch operations refer to the presence of one or more points of contacts and any movement or break of the contacts that are simultaneously sensed by the touch screen 3.

In block S02, the determination module 202 determines a selection region on the touch screen 3 according to a touch operation that is detected from the touch screen 3. The touch operation may include two contacts on two points of the touch screen 3 or a movement track of one or two contracts on the touch screen 3. The selection region is defined as a polygon region that is determined according to the two contacts on two points of the touch screen 3 or the movement track of one or two contracts.

If the touch operation includes the two contacts on two points of the touch screen 3, and the touch operation is maintained for a predetermined time (e.g., one or two seconds), the determination module 202 determines a rectangle selection region on the touch screen 3. A diagonal of the rectangle selection region connects to the two points that are two vertices of the rectangle selection region. Four sides of the rectangle selection region correspondingly parallel with four boundaries of the touch screen 3.

If the touch operation includes the two contacts that respectively and synchronously move from a start point of the touch screen 3 in a random direction, and stop moving on an end point of the touch screen 3, the determination module 202 determines the selection region according to the movement track of the touch operation with the two contacts.

If the touch operation includes the one contact that moves from an origin point of the touch screen 3 in a random direction, and stops moving on the origin point, the determination module 202 determines the selection region according to the movement track of the touch operation with the contact.

If the determination module 202 does not determine a selection region according to the touch operation, the procedure ends.

In block S03, the selection module 203 selects the objects displayed on the touch screen according to the determined selection region. The selection module 203 may select the objects located in the selection region, or select the objects whose locations are overlapping with the selection region.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor;
a touch screen;
one or more programs stored in the storage system and executed by the at least one processor, the one or more programs comprising:
a detection module that detects touch operations performed on the touch screen;
a determination module that determines a selection region on the touch screen according to a touch operation that comprises two contacts on two points of the touch screen or a movement track of one or two contacts on the touch screen, wherein the selection region is defined as a polygon region;
a selection module that selects one or more objects displayed on the touch screen according to the determined selection region.

2. The electronic device of claim 1, wherein the determination module determines a rectangle selection region on the touch screen, upon the condition that the two contacts on two points of the touch screen are detected, and the touch operation is maintained for a predetermined time.

3. The electronic device of claim 2, wherein the rectangle selection region comprises a diagonal that connects to the two points that are two vertices of the rectangle selection region, and four sides that correspondingly parallel with four boundaries of the touch screen.

4. The electronic device of claim 1, wherein the determination module determines the selection region according to the movement track of the touch operation with the two contacts, if the two contacts respectively and synchronously move from a start point of the touch screen in a random direction and stop moving on an end point of the touch screen.

5. The electronic device of claim 1, wherein the determination module determines the selection region according to the movement track of the touch operation with the one contact, if the contact moves from an origin point of the touch screen in a random direction and stops moving on the origin point.

6. The electronic device of claim 1, wherein the selection module selects the objects located in the selection region, or selects the objects whose locations are overlapping with the selection region.

7. A method for selecting objects of an electronic device, the method comprising:
(a) detecting touch operations performed on a touch screen of the electronic device;
(b) determining a selection region on the touch screen according to a touch operation that comprises two contacts on two points of the touch screen or a movement track of one or two contacts on the touch screen, wherein the selection region is defined as a polygon region;
(c) selecting one or more objects displayed on the touch screen according to the determined selection region.

8. The method of claim 7, wherein the block (b) further comprises:
determining a rectangle selection region on the touch screen, upon the condition that the two contacts on two points of the touch screen are detected, and the touch operation is maintained for a predetermined time.

9. The method of claim 8, wherein the rectangle selection region comprises a diagonal that connects to the two points that are two vertices of the rectangle selection region, and four sides that correspondingly parallel with four boundaries of the touch screen.

10. The method of claim 7, wherein the selection region is determined according to the movement track of the touch operation with the two contacts, upon the condition that the two contacts respectively and synchronously move from a start point of the touch screen in a random direction and stop moving on an end point of the touch screen.

11. The method of claim 7, wherein the selection region is determined according to the movement track of the touch operation with the one contact, upon the condition that the contact moves from an origin point of the touch screen in a random direction and stops moving on the origin point.

12. The method of claim 7, wherein the block (c) further comprises:
selecting the objects located in the selection region, or selecting the objects whose locations are overlapping with the selection region.

13. A non-transitory storage medium storing a set of instructions, the set of instructions capable of being executed by a processor of an electronic device, causes the processor to execute a method for selecting objects of the electronic device, the method comprising:
(a) detecting touch operations performed on a touch screen of the electronic device;
(b) determining a selection region on the touch screen according to a touch operation that comprises two contacts on two points of the touch screen or a movement track of one or two contacts on the touch screen, wherein the selection region is defined as a polygon region;
(c) selecting one or more objects displayed on the touch screen according to the determined selection region.

14. The storage medium of claim 13, wherein the block (b) further comprises:
determining a rectangle selection region on the touch screen, upon the condition that the two contacts on two points of the touch screen are detected, and the touch operation is maintained for a predetermined time.

15. The storage medium of claim 14, wherein the rectangle selection region comprises a diagonal that connects to the two points that are two vertices of the rectangle selection region, and four sides that correspondingly parallel with four boundaries of the touch screen.

16. The storage medium of claim 13, wherein the selection region is determined according to the movement track of the touch operation with the two contacts, upon the condition that the two contacts respectively and synchronously move from a start point of the touch screen in a random direction and stop moving on an end point of the touch screen.

17. The storage medium of claim 13, wherein the selection region is determined according to the movement track of the touch operation with the one contact, upon the condition that the contact moves from an origin point of the touch screen in a random direction and stops moving on the origin point.

18. The storage medium of claim 13, wherein the block (c) further comprises:
selecting the objects located in the selection region, or selecting the objects whose locations are overlapping with the selection region.
